(19) United States
(12) Patent Application Publication
(10) Pub. No.: US 2020/0251730 A1
(43) Pub. Date: Aug. 6, 2020

(54) POSITIVE ELECTRODE ACTIVE MATERIAL FOR ALKALINE STORAGE BATTERY

(71) Applicant: TANAKA CHEMICAL CORPORATION, Fukui (JP)

(72) Inventors: Taiki YASUDA, Fukui (JP); Mikio HATA, Fukui (JP)

(73) Assignee: TANAKA CHEMICAL CORPORATION, Fukui (JP)

(21) Appl. No.: 16/637,078

(22) PCT Filed: Sep. 5, 2018
(86) PCT No.: PCT/JP2018/032814

§ 371 Date: Feb. 6, 2020

(30) Foreign Application Priority Data
Sep. 11, 2017 (JP) 2017-173897

(51) Int. Cl. H01M 4/52; H01M 4/32; H01M 10/30

(52) U.S. Cl. CPC H01M 4/52; H01M 2004/028; H01M 10/30; H01M 4/32

(57) ABSTRACT

To provide a positive electrode active material for an alkaline storage battery having an excellent utilization factor even under a high-temperature condition. A positive electrode active material for an alkaline storage battery, having a hydroxide particle containing nickel, the hydroxide particle containing solid-solubilized cobalt, and a covering layer containing cobalt, the covering layer covering the hydroxide particle, in which the positive electrode active material has a diffraction peak between diffraction angles of 65° and 66°, the diffraction angles represented by 2θ in a diffraction pattern obtained by X-ray diffraction measurement, a content by percentage of trivalent cobalt in the solid-solubilized cobalt is 30% by mass or more, a ratio of a content by percentage of the solid-solubilized trivalent cobalt in positive electrode active material particles for an alkaline storage battery, the particles having a secondary particle diameter (≥D10) where a cumulative volume percentage is 10.0% by volume or less, in the positive electrode active material for an alkaline storage battery to the content by percentage of the solid-solubilized trivalent cobalt in the positive electrode active material for an alkaline storage battery is 0.80 or more and 1.20 or less, and a ratio of a content by percentage of the solid-solubilized trivalent cobalt in positive electrode active material particles for an alkaline storage battery, the particles having a secondary particle diameter (≥D90) where a cumulative volume percentage is 90.0% by volume or more, in the positive electrode active material for an alkaline storage battery to the content by percentage of the solid-solubilized trivalent cobalt in the positive electrode active material for an alkaline storage battery is 0.80 or more and 1.20 or less.

### BACKGROUND

### 1. Field of the Disclosure

The present disclosure relates to a positive electrode active material to be used in a positive electrode of an alkaline storage battery, and particularly relates to a positive electrode active material for an alkaline storage battery having an excellent utilization factor even under a high-temperature condition.

### 2. Discussion of the Background Art

In recent years, alkaline storage batteries have been used in a wide range of fields such as vehicles because of features such as excellent large current discharge and low-temperature characteristics, and long life. As a positive electrode active material for an alkaline storage battery, for example, a nickel hydroxide particle is used.

On the other hand, improvements in the utilization factor have been demanded of the alkaline storage batteries as well as other storage batteries, and moreover, being capable of exhibiting an excellent utilization factor even under a high-temperature usage condition has also been demanded.

Thus, a positive electrode active material in an alkaline storage battery, wherein a surface of a nickel hydroxide particle is covered with a cobalt hydroxide layer, and cobalt in the cobalt hydroxide layer mainly contains divalent cobalt, is proposed (Patent Literature 1) in order to improve the utilization factor of the alkaline storage battery. Moreover, a positive electrode active material in an alkaline storage battery, containing a cobalt compound such that a surface of a nickel hydroxide particle is covered with a cobalt oxyhydroxide layer, and the valence number of cobalt in the cobalt oxyhydroxide layer is 2.1 to 3.0, is proposed (Patent Literature 2) in order to suppress self-discharge of an alkaline storage battery.

However, even though an alkaline storage battery having satisfactory utilization factor and self-discharge characteristics is obtained with the positive electrode active material of Patent Literature 1 or Patent Literature 2, there has been room for improvements in that a sufficient utilization factor is not obtained in a high-temperature environment in some cases.

### DOCUMENT LIST

### PATENT LITERATURES

Patent Literature 1: Japanese Patent Application Publication No. 7-320735

Patent Literature 2: Japanese Patent Application Publication No. 2014-169201

### SUMMARY

### Brief Description of the Drawings

### Detailed Description of the Preferred Embodiment

### Technical Problem

In view of the circumstances, it is an object of the present disclosure to provide a positive electrode active material for an alkaline storage battery having an excellent utilization factor even under a high-temperature condition.

### Solution to Problem

An aspect of the present disclosure is a positive electrode active material for an alkaline storage battery, having: a hydroxide particle containing nickel, the hydroxide particle containing solid-solubilized cobalt; and a covering layer containing cobalt, the covering layer covering the hydroxide particle, wherein the positive electrode active material has a diffraction peak between diffraction angles of 65° and 66°, the diffraction angles represented by 2θ in a diffraction pattern obtained by X-ray diffraction measurement, a content by percentage of trivalent cobalt in the solid-solubilized cobalt is 30% by mass or more, a ratio of a content by percentage of the solid-solubilized trivalent cobalt in positive electrode active material particles for an alkaline storage battery, the particles having a secondary particle diameter (≤D10) where a cumulative volume percentage is 10.0% by volume or less, in the positive electrode active material for an alkaline storage battery to the content by percentage of the solid-solubilized trivalent cobalt in the positive electrode active material for an alkaline storage battery is 0.80 or more and 1.20 or less, and a ratio of a content by percentage of the solid-solubilized trivalent cobalt in positive electrode active material particles for an alkaline storage battery, the particles having a secondary particle diameter (≥D90) where a cumulative volume percentage is 90.0% by volume or more, in the positive electrode active material for an alkaline storage battery to the content by percentage of the solid-solubilized trivalent cobalt in the positive electrode active material for an alkaline storage battery is 0.80 or more and 1.20 or less.

An aspect of the present disclosure is the positive electrode active material for an alkaline storage battery, wherein the diffraction peak is derived from a trivalent cobalt compound represented by CoHO₂.

An aspect of the present disclosure is the positive electrode active material for an alkaline storage battery, wherein [Secondary particle diameter (D90) of the positive electrode active material for an alkaline storage battery, where cumulative volume percentage is 90.0% by volume—Secondary particle diameter (D10) of the positive electrode active material for an alkaline storage battery, where cumulative volume percentage is 10.0% by volume]/Secondary particle diameter (D50) of the positive electrode active material for an alkaline storage battery, where the cumulative volume percentage is 50.0% by volume, is 0.85 or more.

An aspect of the present disclosure is a positive electrode having the above-described positive electrode active material for an alkaline storage battery.

An aspect of the present disclosure is an alkaline storage battery provided with the above-described positive electrode.

### Effects of Invention

According to an aspect of the present disclosure, a positive electrode active material for an alkaline storage battery having an excellent utilization factor even under a high-temperature condition can be obtained due to a ratio of a content by percentage of solid-solubilized trivalent cobalt in positive electrode active material particles for an alkaline storage battery, the particles having a secondary particle diameter (≤D10) where a cumulative volume percentage is 10.0% by volume or less, in the positive electrode active material for an alkaline storage battery to a content by percentage of the solid-solubilized trivalent cobalt in the positive electrode active material for an alkaline storage battery being 0.80 or more and 1.20 or less, and a ratio of a content by percentage of the solid-solubilized trivalent cobalt in positive electrode active material particles for an alkaline storage battery, the particles having a secondary particle diameter (≥D90) where a cumulative volume percentage is 90.0% by volume or more, in the positive electrode active material for an alkaline storage battery to the content by percentage of the solid-solubilized trivalent cobalt in the positive electrode active material for an alkaline storage battery being 0.80 or more and 1.20 or less.

According to an aspect of the present disclosure, voids among positive electrode active materials for an alkaline storage battery are reduced due to [Secondary particle diameter of positive electrode active material for alkaline storage battery, where cumulative volume percentage is 90.0% by volume—Secondary particle diameter of positive electrode active material for alkaline storage battery, where cumulative volume percentage is 10.0% by volume]/Secondary particle diameter of positive electrode active material for alkaline storage battery, where cumulative volume percentage is 50.0% by volume, being 0.85 or more, and therefore in an alkaline storage battery using the positive electrode active material in the positive electrode, a utilization factor is excellent at high temperatures and a satisfactory volume capacity can be obtained.

### SUMMARY

### BRIEF DESCRIPTION OF THE DRAWINGS

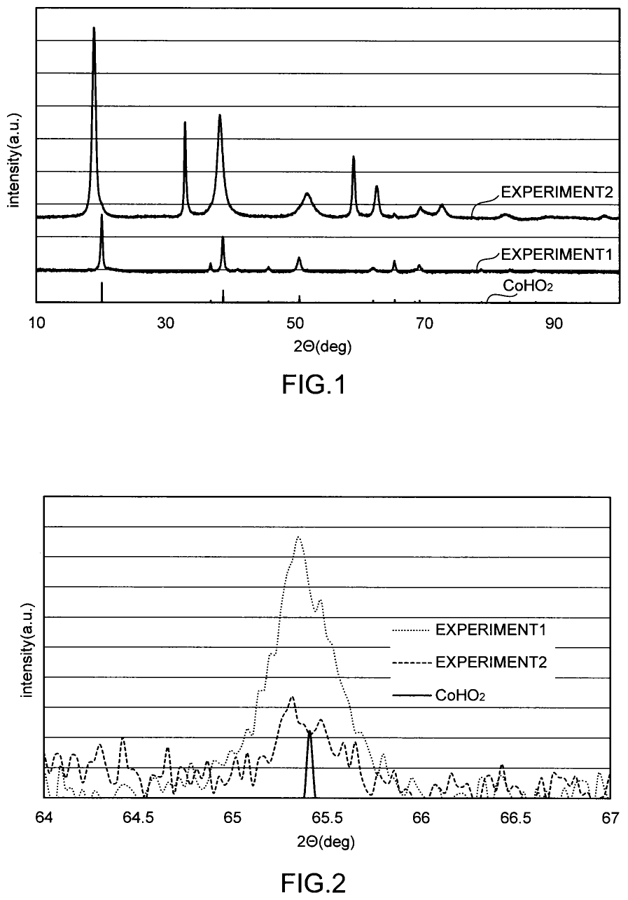

FIG. 1 A graph showing diffraction patterns in X-ray diffraction measurement of Experiment 1, Experiment 2, and cobalt oxyhydroxide.

FIG. 2 A partially enlarged graph of the graph showing diffraction patterns in FIG. 1.

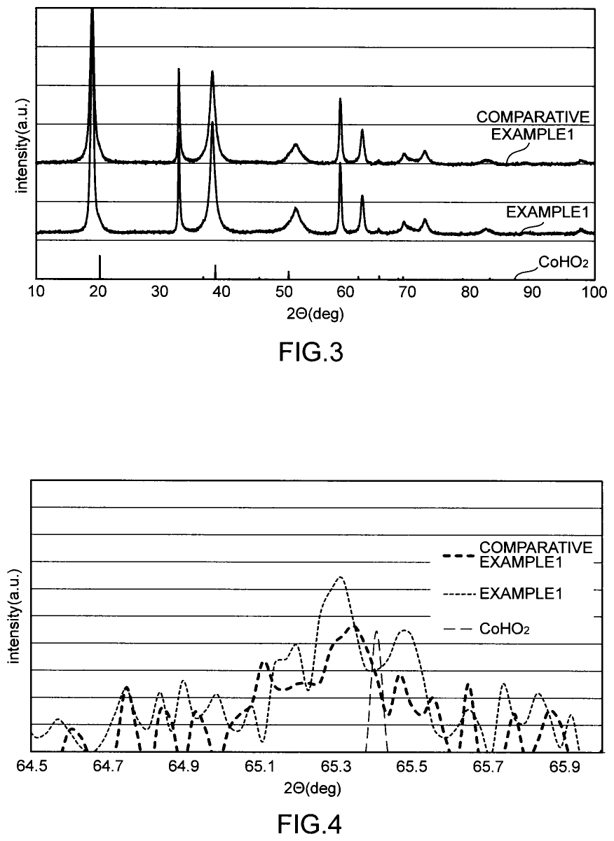

FIG. 3 A graph showing diffraction patterns in X-ray diffraction measurement of Example, Comparative Example, and cobalt oxyhydroxide

FIG. 4 A partially enlarged graph of the graph showing diffraction patterns in FIG. 3.

### DETAILED DESCRIPTION OF THE PREFERRED EMBODIMENT

Hereinafter, a positive electrode active material for an alkaline storage battery of the present disclosure will be described in detail.

The positive electrode active material for an alkaline storage battery of the present disclosure contains a plurality of positive electrode active material particles for an alkaline storage battery, each formed by aggregation of a plurality of primary particles each having: a hydroxide particle containing nickel, the hydroxide particle containing solid-solubilized cobalt; and a covering layer containing a cobalt, the covering layer covering the hydroxide particle. The positive electrode active material for an alkaline storage battery has a diffraction peak between diffraction angles of 65° and 66°, the diffraction angles represented by 2θ in a diffraction pattern obtained by X-ray diffraction measurement.

Moreover, in the positive electrode active material for an alkaline storage battery, a content by percentage of trivalent cobalt in cobalt solid-solubilized in the hydroxide particle containing nickel is 30% by mass or more, a ratio of a content by percentage of trivalent cobalt solid-solubilized in hydroxide particles containing nickel and being positive electrode active material particles for an alkaline storage battery, the particles having a secondary particle diameter (≤D10) where a cumulative volume percentage is 10.0% by volume or less, in the positive electrode active material for an alkaline storage battery to the content by percentage of trivalent cobalt solid-solubilized in the hydroxide particle containing nickel in the positive electrode active material for an alkaline storage battery is 0.80 or more and 1.20 or less, and a ratio of a content by percentage of trivalent cobalt solid-solubilized in hydroxide particles containing nickel and being positive electrode active material particles for an alkaline storage battery, the particles having a secondary particle diameter (≥D90) where a cumulative volume percentage is 90.0% by volume or more, in the positive electrode active material for an alkaline storage battery to the content by percentage of trivalent cobalt solid-solubilized in the hydroxide particle containing nickel in the positive electrode active material for an alkaline storage battery is 0.80 or more and 1.20 or less.

A positive electrode active material particle for an alkaline storage battery, which forms the positive electrode active material for an alkaline storage battery of the present disclosure, has a hydroxide particle containing nickel and a covering layer containing cobalt, the covering layer covering the hydroxide particle, and has a diffraction peak between diffraction angles of 65° and 66°, the diffraction angles represented by 2θ in a diffraction pattern obtained by X-ray diffraction measurement. Moreover, solid-solubilized cobalt is contained in the hydroxide particle containing nickel. The positive electrode active material particle for an alkaline storage battery has as a core particle a particle of hydroxide containing nickel (Ni), and the core particle is covered with the covering layer containing cobalt. Accordingly, the positive electrode active material particle for an alkaline storage battery is a particle having a core·shell structure and is a nickel-containing hydroxide particle covered with a cobalt-containing compound, the particle having a core which is the hydroxide particle containing nickel and a shell which is the cobalt containing compound.

The shape of the positive electrode active material for an alkaline storage battery is not particularly limited, and examples thereof include an approximately spherical shape.

The nickel-containing hydroxide particle covered with a cobalt-containing compound, which is a positive electrode active material particle for an alkaline storage battery, takes an aspect of a secondary particle formed by aggregation of a plurality of primary particles. The particle size distribution of the positive electrode active material for an alkaline storage battery of the present disclosure is not particularly limited, but, for example, the lower limit value of the secondary particle diameter D50 (hereinafter, sometimes referred to as “D50”) where the cumulative volume percentage is 50% by volume is preferably 2.0 μm, more preferably 3.0 μm, and particularly preferably 4.0 μm. On the other hand, the upper limit value of D50 of the nickel-containing hydroxide particle covered with a cobalt-containing compound is preferably 10.0 μm from the viewpoint of balance between improving the density and securing the contact surface with an electrolytic solution, and particularly preferably 8.0 μm from the viewpoint of further improving the utilization factor under a high-temperature condition. It is to be noted that the above-described lower limit values and upper limit values can arbitrarily be combined.

The BET specific surface area of the nickel-containing hydroxide particle covered with a cobalt-containing compound is not particularly limited, but, from the viewpoint of, for example, balance between improving the density and securing the contact surface with an electrolytic solution, the lower limit value thereof is preferably 5.0 m²/g, and particularly preferably 10.0 m²/g, and the upper limit value thereof is preferably 30.0 m²/g, and particularly preferably 25.0 m²/g. It is to be noted that the above-described upper limit values and lower limit values can arbitrarily be combined.

The tap density of the nickel-containing hydroxide particle covered with a cobalt-containing compound is not particularly limited, but is preferably 1.5 g/cm³ or more, and particularly preferably 1.7 g/cm³ or more from the viewpoint of, for example, improvements in the filling degree in using the particle as a positive electrode active material.

The bulk density of the nickel-containing hydroxide particle covered with a cobalt-containing compound is not particularly limited, but is preferably 0.8 g/cm³ or more, and particularly preferably 1.0 g/cm³ or more from the viewpoint of, for example, improvements in the filling degree in using the particle as a positive electrode active material.

The positive electrode active material particle for an alkaline storage battery is, as described above, a nickel-containing hydroxide particle covered with a cobalt-containing compound, in which a covering layer containing cobalt is formed on the surface of a hydroxide particle containing nickel, the hydroxide particle containing a solid-solubilized cobalt. The covering layer containing cobalt contains a compound containing cobalt. Moreover, the covering layer containing cobalt may cover the whole surface of the hydroxide particle containing nickel, or may cover a region of a part of the surface of the hydroxide particle containing nickel.

The mass proportion of cobalt in the covering layer containing cobalt in the nickel-containing hydroxide particle covered with a cobalt-containing compound is not particularly limited, but the lower limit value thereof is preferably 1.0% by mass, and particularly preferably 2.0% by mass from the viewpoint of further improving the utilization factor under a high-temperature condition. On the other hand, the upper limit value of the mass proportion of cobalt in the covering layer containing cobalt in the nickel-containing hydroxide particle covered with a cobalt-containing compound is preferably 5.0% by mass, and particularly preferably 4.0% by mass. It is to be noted that the above-described lower limit values and upper limit values can arbitrarily be combined.

Moreover, cobalt in the covering layer containing cobalt is trivalent cobalt.

Examples of the chemical structure of trivalent cobalt include cobalt oxyhydroxide (CoHO₂) (in the present specification, cobalt oxyhydroxide is sometimes simply written as “cobalt oxyhydroxide” or “CoHO2”).

The covering layer containing trivalent cobalt has a diffraction peak between diffraction angles of 65° and 66°, the diffraction angles represented by 2θ in a diffraction pattern obtained by X-ray diffraction measurement. The diffraction peak is mainly derived from cobalt oxyhydroxide (CoHO₂).

The hydroxide particle containing nickel (Ni), the hydroxide particle containing solid-solubilized cobalt, is not particularly limited as long as the hydroxide particle contains nickel (Ni) and solid-solubilized cobalt, and examples thereof include a particle in which cobalt is solid-solubilized in nickel hydroxide, and a particle in which cobalt is solid-solubilized in a hydroxide containing nickel (Ni) and, additional transition metal element or elements (for example, at least one transition metal element selected from the group consisting of magnesium (Mg), manganese (Mn), zinc (Zn), and aluminum (Al)).

The content of nickel in the hydroxide particle containing nickel, in which cobalt is solid-solubilized, in the nickel-containing hydroxide particle covered with a cobalt-containing compound is not particularly limited, but the lower limit value thereof is preferably 40% by mass, more preferably 45% by mass, and particularly preferably 50% by mass. On the other hand, the upper limit value of the content of nickel in the hydroxide particle containing nickel, in which cobalt is solid-solubilized, in the nickel-containing hydroxide particle covered with a cobalt-containing compound is preferably 60% by mass, and particularly preferably 57% by mass. It is to be noted that the above-described lower limit values and upper limit values can arbitrarily be combined.

The amount of cobalt solid-solubilized in the hydroxide particle containing nickel in the nickel-containing hydroxide particle covered with a cobalt-containing compound is not particularly limited, but the lower limit value thereof is preferably 0.10% by mass, more preferably 0.20% by mass, and particularly preferably 0.50% by mass from the viewpoint of further improving the utilization factor under a high-temperature condition. On the other hand, the upper limit value of the amount of cobalt solid-solubilized in the hydroxide particle containing nickel in the nickel-containing hydroxide particle covered with a cobalt-containing compound is preferably 5.0% by mass, more preferably 3.0% by mass, and particularly preferably 2.0% by mass. It is to be noted that the above-described lower limit values and upper limit values can arbitrarily be combined.

Moreover, in the positive electrode active material for an alkaline storage battery of the present disclosure, trivalent cobalt accounts for at least 30% by mass in cobalt solid-solubilized in the hydroxide particle containing nickel from the viewpoint of the utilization factor under a high-temperature condition. The lower limit value of the content by percentage of trivalent cobalt in cobalt solid-solubilized in the hydroxide particle containing nickel is preferably 35% by mass, and particularly preferably 40% by mass from the viewpoint of improving the utilization factor under a high-temperature condition more. On the other hand, the upper limit value of the content by percentage of trivalent cobalt in cobalt solid-solubilized in the hydroxide particle containing nickel is preferably 100% by mass from the viewpoint of obtaining a further excellent utilization factor under a high temperature condition, and particularly preferably 70% by mass from the viewpoint of making an oxidation treatment step from divalent cobalt to trivalent cobalt easy. It is to be noted that the above-described lower limit values and upper limit values can arbitrarily be combined.

Examples of the chemical structure of trivalent cobalt solid-solubilized in the hydroxide particle containing nickel include cobalt oxyhydroxide (CoHO₂).

As described above, when cobalt oxyhydroxide is solid-solubilized in the hydroxide particle containing nickel, the hydroxide particle containing nickel as well as the covering layer containing cobalt oxyhydroxide (CoHO₂) has a diffraction peak between diffraction angles of 65° and 66°, the diffraction angles represented by 2θ in a diffraction pattern obtained by X-ray diffraction measurement.

Examples of cobalt other than trivalent cobalt in cobalt solid-solubilized in the hydroxide particle containing nickel include divalent cobalt. Examples of the chemical structure of divalent cobalt include cobalt hydroxide (Co(OH)₂).

The shape of the hydroxide particle containing nickel, in which cobalt is solid-solubilized, is not particularly limited, and examples thereof include an approximately spherical shape.

In the positive electrode active material for an alkaline storage battery of the present disclosure, having a plurality of nickel-containing hydroxide particles each covered with a cobalt-containing compound, the ratio of the content by percentage of trivalent cobalt solid-solubilized in the hydroxide particles containing nickel in secondary particle diameters of ≤D10 (Hereinafter, sometimes referred to as “≤D10” or “D10 or less.”) where the cumulative volume percentage is 10.0% by volume or less in the positive electrode active material for an alkaline storage battery to the content by percentage of trivalent cobalt solid-solubilized in the hydroxide particles containing nickel in the positive electrode active material for an alkaline storage battery is 0.80 or more and 1.20 or less, and, from the viewpoint of obtaining a further excellent utilization factor under a high-temperature condition, preferably 0.90 or more and 1.15 or less. Further, the ratio of the content by percentage of trivalent cobalt solid-solubilized in the hydroxide particles containing nickel in secondary particle diameters of ≥D90 (Hereinafter, sometimes referred to as “≥D90” or “D90 or more.”) where the cumulative volume percentage is 90.0% by volume or more in the positive electrode active material for an alkaline storage battery to the content by percentage of trivalent cobalt solid-solubilized in the hydroxide particles containing nickel in the positive electrode active material for an alkaline storage battery is 0.80 or more and 1.20 or less, and, from the viewpoint of obtaining a further excellent utilization factor under a high-temperature condition, preferably 0.90 or more and 1.15 or less.

As can be seen from those described above, the content by percentage of trivalent cobalt solid-solubilized in the hydroxide particles containing nickel is made uniform in each nickel-containing hydroxide particle covered with a cobalt-containing compound in the positive electrode active material for an alkaline storage battery of the present disclosure.

The content by percentage of trivalent cobalt in cobalt solid-solubilized in the hydroxide particles containing nickel in D10 or less is not particularly limited, but is preferably the same or approximately the same as the content by percentage of trivalent cobalt in the positive electrode active material for an alkaline storage battery, and accordingly, the lower limit value thereof is preferably 30% by mass, more preferably 35% by mass, and particularly preferably 40% by mass from the viewpoint of improving the utilization factor under a high-temperature condition more. On the other hand, the upper limit value thereof is preferably 100% by mass, and, from the viewpoint of making an oxidation treatment step from divalent cobalt to trivalent cobalt, particularly preferably 70% by mass. It is to be noted that the above-described lower limit values and upper limit values can arbitrarily be combined.

The content by percentage of trivalent cobalt in cobalt solid-solubilized in the hydroxide particles containing nickel in D90 or more is not particularly limited, but is preferably the same or approximately the same as the content by percentage of trivalent cobalt in the positive electrode active material for an alkaline storage battery and in D10 or less, and accordingly, the lower limit value thereof is preferably 30% by mass, more preferably 35% by mass, and particularly preferably 40% by mass from the viewpoint of improving the utilization factor under a high-temperature condition more. On the other hand, the upper limit value thereof is preferably 100% by mass, and, from the viewpoint of making an oxidation treatment step from divalent cobalt to trivalent cobalt, particularly preferably 70% by mass. It is to be noted that the above-described lower limit values and upper limit values can arbitrarily be combined.

In the positive electrode active material for an alkaline storage battery of the present disclosure, [(Secondary particle diameter D90 (hereinafter, sometimes referred to as “D90”) where the cumulative volume percentage is 90% by volume—Secondary particle diameter D10 (hereinafter, sometimes referred to as “D10”) where the cumulative volume percentage is 10% by volume)/D50], which is an index of indicating the spread of a particle size distribution, is not particularly limited, but is preferably 0.85 or more, and particularly preferably 0.90 or more from the viewpoint of reducing the voids among the positive electrode active materials when the positive electrode active material for an alkaline storage battery is made into a positive electrode to enable obtaining an excellent utilization factor at high temperatures and a satisfactory volume capacity in an alkaline storage battery using the positive electrode active material in the positive electrode. On the other hand, the upper limit value of [(D90-D10)/D50] is not particularly limited, and examples thereof include 1.20.

Thereafter, an example of a method for producing the positive electrode active material for an alkaline storage battery of the present disclosure will be described.

The production method includes, for example, a covering step of preparing a hydroxide particle containing nickel, in which cobalt is solid-solubilized, and supplying a cobalt salt solution and an alkali solution into suspended matter (for example, aqueous suspended matter) containing the hydroxide particle containing nickel, in which cobalt is solid-solubilized, to form a covering containing cobalt on the surface of the hydroxide particle containing nickel, in which cobalt is solid-solubilized, thereby obtaining a hydroxide particle containing nickel, the hydroxide particle having a covering formed thereon; and an oxidation step of supplying a gas containing oxygen with a microbubble generator into the suspended matter containing the hydroxide particle containing nickel, the hydroxide particle having a covering formed thereon, while bringing an oxidation catalyst into contact with the suspended matter (for example, aqueous suspended matter) containing the hydroxide particle containing nickel, the hydroxide particle having a covering formed thereon, thereby oxidizing solid-solubilized cobalt and cobalt contained in the covering layer.

Hereinafter, details on the above-described example of the production method will be described. Firstly, a salt solution (for example, sulfate solution) of nickel, cobalt, and an additional transition metal element (for example, magnesium, manganese, zinc, and/or aluminum) and a complexing agent are reacted by a co-precipitation method to produce a hydroxide particle containing nickel, the hydroxide particle containing solid-solubilized cobalt (for example, a particle in which divalent cobalt is solid-solubilized in nickel hydroxide, and a particle in which divalent cobalt is solid-solubilized in a hydroxide containing nickel, and an additional transition metal element (for example, magnesium, manganese, zinc, and/or aluminum), thereby obtaining suspended matter in the form of slurry containing the hydroxide particle containing nickel. As described above, as the solvent for the suspended matter, for example, water is used.

The complexing agent is not particularly limited as long as the complexing agent can form a complex with nickel, cobalt, and an ion of the additional transition metal element in an aqueous solution, and examples thereof include ammonium ion-supplying bodies (such as ammonium sulfate, ammonium hydrochloride, ammonium carbonate, and ammonium fluoride), hydrazine, ethylenediaminetetraacetic acid, nitrilotriacetic acid, uracildiacetic acid, and glycine. It is to be noted that if necessary, an alkali metal hydroxide (for example, sodium hydroxide or potassium hydroxide) may be added in order to adjust the pH value of the aqueous solution in performing precipitation.

When a complexing agent is supplied continuously into a reaction tank in addition to the salt solution, nickel, cobalt, and the additional transition metal element are reacted and the hydroxide particle containing nickel, in which cobalt is solid-solubilized, is produced. In performing reaction, the substances in the reaction tank are stirred appropriately while the temperature of the reaction tank is controlled within the range of, for example, 10° C. to 80° C., preferably 20 to 70° C., and the pH value in the reaction tank is controlled within the range of, for example, a pH of 9 to a pH of 13, preferably a pH of 11 to 13 as the pH at 25° C. as a standard. Examples of the reaction tank include a continuous type to allow the formed hydroxide particle containing nickel to overflow for the purpose of separation.

Thereafter, the cobalt salt solution (such as, for example, an aqueous solution of cobalt sulfate), and, if necessary, a solution of a salt (for example, a sulfate solution) of the additional transition metal element (for example, magnesium, manganese, zinc, and/or aluminum), and an alkali solution (such as, for example, a sodium hydroxide aqueous solution) are added under stirring to the suspended matter containing the hydroxide particle containing nickel, in which cobalt is solid-solubilized, thereby forming a covering containing as a main component a cobalt compound having a valence number of cobalt of two, such as cobalt hydroxide, on the surface of the hydroxide particle containing nickel, in which cobalt is solid-solubilized, by neutralization crystallization. It is preferable to keep the pH in the step of forming a covering within the range of a pH of 9 to 13 at 25° C. as a standard. By the covering step, a hydroxide particle containing nickel, the hydroxide particle having a covering layer containing cobalt formed thereon, can be obtained. The hydroxide particle containing nickel, the hydroxide particle having a covering layer containing cobalt formed thereon, can be obtained as suspended matter in the form of slurry.

Thereafter, a gas containing oxygen is supplied with a microbubble generator into the suspended matter containing the hydroxide particle containing nickel, the hydroxide particle having a covering layer formed thereon, under stirring and in the presence of an oxidizing catalyst to oxidize divalent cobalt in the hydroxide particle containing nickel, the hydroxide particle having a covering layer formed thereon into trivalent cobalt.

Examples of the oxidation catalyst include a compound containing at least one metal selected from the group consisting of iron, nickel, and chromium, and/or an ion of the metal, and specific examples thereof include stainless steel.

The average diameter of the gas (bubbles) containing oxygen, to be supplied with a microbubble generator is not particularly limited, but is, for example, preferably 1.0 μm or more and 50 μm or less, and particularly preferably 2.0 μm or more and 30 μm or less. By controlling the average diameter of the bubbles in the range, divalent cobalt contained in the covering layer can be oxidized into trivalent cobalt, and divalent cobalt solid-solubilized in the hydroxide particle containing nickel can also be oxidized into trivalent cobalt more surely. Examples of the gas containing oxygen include a gas composed of oxygen and a gas containing oxygen and additional element or elements, such as air.

Examples of the microbubble generator include YJ nozzle of ENVIROVISION CO., LTD.

The ratio of the amount of oxygen (volume) in the gas containing oxygen, to be supplied into the suspended matter containing the hydroxide particle having a covering layer formed thereon to the volume of the suspended matter containing the hydroxide particle having a covering layer formed thereon is not particularly limited, and is adjusted to, for example, 1.00 or more and 2.55 or less. By setting the ratio to the range, divalent cobalt solid-solubilized in the hydroxide particle containing nickel can be oxidized into trivalent cobalt efficiently and surely.

Moreover, if necessary, a step of separating the oxidation-treated suspended matter containing the hydroxide particle containing nickel, the hydroxide particle having a covering layer formed thereon, into a solid phase and a liquid phase and drying the solid phase separated from the liquid phase may further be included after the oxidation step. Moreover, if necessary, the solid phase may be washed with a weak alkali water before drying the solid phase. Moreover, if necessary, a compound (for example, an oxide) of an additional transition metal element (for example, ytterbium, yttrium, zirconium, tungsten, molybdenum, niobium, titanium, magnesium, manganese, zinc, and/or aluminum) may be added by a known method in order to obtain a desired effect (high temperature characteristics, an improvement in electrical conductivity, or preservation of an electrically conductive network).

Thereafter, a positive electrode using the positive electrode active material for an alkaline storage battery of the present disclosure and an alkaline storage battery using the positive electrode will be described. The alkaline storage battery is provided with a positive electrode using the above-described positive electrode active material for an alkaline storage battery of the present disclosure, a negative electrode, an alkaline electrolytic solution, and a separator.

The positive electrode is provided with a positive electrode collector and a positive electrode active material layer formed on the surface of the positive electrode collector. The positive electrode active material layer has a positive electrode active material for an alkaline storage battery, a binder (binding agent), and, if necessary, a conductive assistant. The conductive assistant is not particularly limited as long as the conductive assistant can be used for an alkaline storage battery, and, for example, metal cobalt, cobalt oxide, and the like can be used. The binder is not particularly limited, and examples thereof include polymer resins, such as, for example, polyvinylidene fluoride (PVdF), butadiene rubber (BR), polyvinyl alcohol (PVA), and carboxymethyl cellulose (CMC), polytetrafluoroethylene (PTFE), and combinations thereof. The positive electrode collector is not particularly limited, and examples thereof include a perforated metal, an expanded metal, wire netting, a foam metal such as, for example, foam nickel, a mesh-like metal fiber sintered body, and a metal-plated resin sheet.

As a method for producing the positive electrode, for example, a positive electrode active material slurry is first prepared by mixing a positive electrode active material for an alkaline storage battery, a conductive assistant, a binder, and water. Subsequently, the positive electrode collector is filled with the positive electrode active material slurry by a known filling method, and the positive electrode active material slurry is dried, and then rolled and fixed with a press or the like.

The negative electrode is provided with a negative electrode collector and a negative electrode active material layer containing a negative electrode active material, the layer formed on the surface of the negative electrode collector. The negative electrode active material is not particularly limited as long as the negative electrode active material is usually used, and, for example, a hydrogen storage alloy particle, a cadmium oxide particle, a cadmium hydroxide particle, and the like can be used. As the negative electrode collector, an electrically conductive metal materials, such as nickel, aluminum, and stainless steel, which are the same materials as the positive electrode collector, can be used.

Moreover, if necessary, a conductive assistant, a binder, or the like may be further added in the negative electrode active material layer. Examples of the conductive assistant and the binder include the conductive assistants and the binders which are the same as those used in the positive electrode material layer.

As a method for producing the negative electrode, for example, a negative electrode active material slurry is first prepared by mixing a negative electrode active material, water, and if necessary, a conductive assistant and/or a binder. Subsequently, the negative electrode collector is filled with the negative electrode active material slurry by a known filling method, and the negative electrode active material slurry is dried, and then rolled and fixed with a press or the like.

In the alkaline electrolytic solution, examples of the solvent include water, and examples of the solute to be dissolved in the solvent include potassium hydroxide, sodium hydroxide, and lithium hydroxide. The solutes may be used singly, or two or more thereof may be used together.

The separator is not particularly limited, and examples thereof include polyolefin nonwoven fabric, such as, for example, polyethylene nonwoven fabric and polypropylene nonwoven fabric, polyamide nonwoven fabric, and those obtained by performing a hydrophilic treatment thereon.

Thereafter, Examples of the present disclosure will be described, but the present disclosure is not limited to these Examples unless deviating from the scope thereof.

Firstly, a suspension of a cobalt hydroxide particle not having a covering layer and a suspension of a nickel hydroxide particle having a covering layer of cobalt hydroxide were each brought into contact with stainless steel, which is an oxidation catalyst, under stirring, and further, an oxidation treatment was performed by supplying air therein, thereby converting cobalt hydroxide to cobalt oxyhydroxide. It is to be noted that in an oxidation treatment performed by adding an alkali to the suspension and heating a resultant mixture, γ-cobalt oxyhydroxide is produced, but by performing the above-described oxidation treatment, cobalt oxyhydroxide represented by a chemical formula CoHO₂ can be produced. Physical properties of the oxidation-treated cobalt hydroxide particle not having a covering layer (Experiment 1) and the oxidation-treated nickel hydroxide particle having a covering layer of cobalt hydroxide (Experiment 2) are shown in Table 1 described below.

TABLE 1

| | | Experiment 1 | Experiment 2 |
|---|---|---|---|
| Ni | % by mass | 0 | 56.6 |
| Total Co | % by mass | 63.4 | 2.91 |
| Co solid-solubilized | % by mass | 63.4 | 0 |
| in hydroxide particle | | | |
| Co in covering layer | % by mass | — | 2.91 |
| Mg | % by mass | 0 | 0 |
| Total oxidized cobalt | % by mass | 63.4 | 2.91 |
| (Co (III)) | | | |
| Total cobalt oxidation | % | 100.00 | 100.00 |
| rate (content by | | | |
| percentage (% by | | | |
| mass) of oxidized | | | |
| cobalt (Co (III)) in | | | |
| total Co) | | | |
| Co compound | — | CoHO2 | CoHO2 |
| species | | | |

X-ray diffraction measurement was conducted for the samples of Experiment 1 and Experiment 2, and for cobalt oxyhydroxide to analyze the diffraction peaks.

In the X-ray diffraction measurement, measurement was conducted using an X-ray diffraction apparatus (Ultima IV, Rigaku Corporation) under the conditions described below.
X-ray: CuKα/40 kV/40 mA
Slit: Divergence=1/2, Light reception=open, Scattering=8.0 mm
Sampling width: 0.03
Scan speed: 20°/min

FIG. 1 and FIG. 2 show the results of the X-ray diffraction measurement for the samples of Experiment 1 and Experiment 2, and for cobalt oxyhydroxide.

As shown in FIG. 1 and FIG. 2, a diffraction peak was observed between diffraction angles of 65° and 66°, the diffraction angles represented by 2θ in the diffraction patterns for any of the samples of Experiment 1 and Experiment 2, and cobalt oxyhydroxide. Accordingly, it was ascertained that the diffraction peak between diffraction angles of 65° and 66°, the diffraction angles represented by 2θ in the diffraction patterns is a peak characteristic of cobalt oxyhydroxide (that is, trivalent cobalt represented by chemical formula CoHO₂).

### Example 1

Synthesis of Hydroxide Particle Containing Nickel, in which Cobalt is Solid-solubilized

An ammonium sulfate aqueous solution (complexing agent) and a sodium hydroxide aqueous solution were dropped into an aqueous solution obtained by dissolving magnesium sulfate, cobalt sulfate, and nickel sulfate in a predetermined ratio, and the resultant mixture was stirred continuously with a stirrer while the pH in the reaction tank was kept at 12.2 at 25° C. as a standard. A produced hydroxide was allowed to overflow from an overflow pipe of the reaction tank and was taken out. Each treatment of washing with water, dehydration, and drying was performed on the hydroxide which was taken out to obtain a hydroxide particle containing nickel, in which cobalt is solid-solubilized.

Formation of Covering Layer Containing Cobalt

The hydroxide particle containing nickel, in which cobalt is solid-solubilized, the hydroxide particle obtained in the manner as described above, was put into an alkali aqueous solution in a reaction bath the pH of which was kept in the range of 9 to 13 at a liquid temperature of 25° C. as a standard with sodium hydroxide. After the hydroxide particle was put into the alkali aqueous solution, a cobalt sulfate aqueous solution the concentration of which was 90 g/L was dropped into the solution under stirring. A sodium hydroxide aqueous solution was dropped appropriately during the dropping to keep the pH of the reaction bath in the range of 9 to 13 at a liquid temperature of 25° C. as a standard to form a covering layer of cobalt hydroxide on the surface of the hydroxide particle, thereby obtaining a suspension of a hydroxide particle containing nickel, in which cobalt is solid-solubilized, the hydroxide particle covered with cobalt hydroxide.

Oxidation treatment on Hydroxide Particle Containing Nickel, in which Cobalt is Solid-solubilized, the Hydroxide Particle Covered with Cobalt Hydroxide

The suspension of the hydroxide particle containing nickel, in which cobalt is solid-solubilized, the hydroxide particle covered with cobalt hydroxide, the suspension obtained in the manner as described above, was brought into contact with stainless steel as an oxidation catalyst while the suspension was stirred, and further, air was supplied into the suspension with a microbubble generator (“YJ nozzle,” ENVIROVISION CO., LTD.) to perform an oxidation treatment. Air was supplied into the suspension in such a way that the ratio of the volume of oxygen contained in the air to the volume of the suspension of the hydroxide particle containing nickel, in which cobalt is solid-solubilized, the hydroxide particle covered with cobalt hydroxide, was 1.28. By the oxidation treatment, cobalt solid-solubilized in the hydroxide particle containing nickel and cobalt hydroxide in the covering layer were each oxidized into cobalt oxyhydroxide, which is trivalent cobalt.

Solid-Liquid Separation and Drying Treatment

Thereafter, each treatment of washing with water, dehydration, and drying was performed on the oxidation-treated suspension to obtain a nickel-containing hydroxide particle of Example 1 covered with a cobalt-containing compound. The physical properties of the nickel-containing hydroxide particle of Example 1 covered with a cobalt-containing compound are shown in Table 2 described below. It is to be noted that in the Example and the Comparative Example in Table 2, the amount of “oxidized cobalt (Co (III)) solid-solubilized in the hydroxide particle” was specified assuming that cobalt solid-solubilized in the hydroxide particle containing nickel is oxidized after all of cobalt in the covering layer was oxidized into trivalent cobalt. The physical properties of the nickel-containing hydroxide particle of Example 1 covered with a cobalt-containing compound are shown in Table 2 described below.

### Comparative Example 1

A nickel-containing hydroxide particle of Comparative Example 1 covered with a cobalt-containing compound, the nickel-containing hydroxide particle having a particle size distribution different from the particle size distribution of Example 1, was obtained by keeping the pH in the reaction tank at 12.0 at a liquid temperature of 25° C. as a standard in place of keeping the pH in the reaction tank at 12.2 at a liquid temperature of 25° C. as a standard in Example 1. The physical properties of the nickel-containing hydroxide particle of Comparative Example 1 covered with a cobalt-containing compound are shown in Table 2 described below.

In Table 2,

the component composition was analyzed using an ICP optical emission spectrometer (Optima (R) 8300, PerkinElmer, Inc.). A value obtained by subtracting the Co content of the hydroxide particle containing nickel, in which cobalt is solid-solubilized, from the Co content of the nickel-containing hydroxide particle covered with a cobalt-containing compound was defined as the Co content in the covering layer.

The BET specific surface area was measured by a one-point BET method using a specific surface area analyzer (Macsorb (R), Mountech Co., Ltd.). p As a classifier, a classifying apparatus (Elbow Jet classifying apparatus EJ-L-3, Nittetsu Mining Co., Ltd.) was used, and classification was performed setting the classifying edge distance M to 41.0 mm, the classifying edge distance F to 30.0 mm, and the air pressure to 0.5 MPa, and feeding the particles to be measured with feed air.

D5, D10, D50, D90, and D95 were measured with a particle size distribution measurement apparatus (LA-950, HORIBA, Ltd.) (principal is laser diffraction/scattering method). Moreover, the value of the particle size distribution width (D90-D10)/D50 was calculated from the measured values of D10, D50, and D90.

TABLE 2

| | | Comparative | |
|---|---|---|---|
| | | Example 1 | Example 1 |
| Ni | % by mass | 55.5 | 55.8 |
| Total Co | % by mass | 4.14 | 4.20 |
| Co solid-solubilized | % by mass | 1.29 | 1.29 |
| in hydroxide particle | | | |
| Co in covering layer | % by mass | 2.85 | 2.91 |
| Mg | % by mass | 0.75 | 0.76 |
| Total oxidized cobalt | % by mass | 3.37 | 3.45 |
| (Co (III)) | | | |
| Total cobalt oxidation | % | 81.40 | 82.14 |
| rate (content by | | | |
| percentage (% by | | | |
| mass) of oxidized | | | |
| cobalt (Co (III)) in | | | |
| total Co) | | | |
| Oxidized cobalt (Co | % by mass | 0.52 | 0.54 |
| (III)) solid-solubilized | | | |
| in hydroxide particle | | | |
| Oxidation rate of Co | % | 40.31 | 41.86 |
| solid-solubilized in | | | |
| hydroxide particle | | | |
| (content by | | | |
| percentage (% by | | | |
| mass) of oxidized | | | |
| cobalt (Co (III)) solid- | | | |
| solubilized in | | | |
| hydroxide particle to | | | |
| Co solid-solubilized | | | |
| in hydroxide particle) | | | |
| Co compound | — | CoHO₂ | CoHO₂ |
| species | | | |
| BET | m²/g | 19.2 | 22.8 |
| D5 | μm | 5.0 | 3.2 |
| D10 | μm | 5.9 | 3.7 |
| D50 | μm | 10.2 | 5.8 |
| D90 | μm | 16.0 | 9.0 |
| D95 | μm | 18.0 | 10.1 |
| (D90 − D10)/D50 | — | 0.99 | 0.91 |

X-ray diffraction measurement was conducted for Example 1, Comparative Example 1, and cobalt oxyhydroxide to analyzes diffraction peaks. The X-ray diffraction measurement was conducted in the same manner as in Experiment 1 and Experiment 2 described above.

The results of the X-ray diffraction measurement for Example 1, Comparative Example 1, and cobalt oxyhydroxide are shown in FIG. 3 and FIG. 4.

As shown in FIG. 3 and FIG. 4, a diffraction peak was observed between diffraction angles of 65° and 66°, the diffraction angles represented by 2θ in the diffraction patterns in any of Example 1 and Comparative Example 1. Accordingly, it was ascertained that in Example 1 and Comparative Example 1, at least part of cobalt solid-solubilized in the hydroxide particle containing nickel is solid-solubilized as cobalt oxyhydroxide, which is trivalent cobalt, and the covering layer has cobalt oxyhydroxide.

The physical properties of the samples of D10 or less, D50, and D90 or more in Example 1 and Comparative Example 1 are shown in Table 3 described below.

TABLE 3

| | | Comparative | Comparative | Comparative | | | |
|---|---|---|---|---|---|---|---|
| | | Example 1 - | Example 1 - | Example 1 - | Example 1 - | Example 1 - | Example 1 - |
| | | D10 or less | D50 | D90 or more | D10 or less | D50 | D90 or more |
| Ni | % by | 54.2 | 56.7 | 57.9 | 51.0 | 55.7 | 57.9 |
| | mass | | | | | | |
| Total Co | % by | 6.22 | 3.69 | 2.66 | 7.79 | 3.88 | 2.34 |
| | mass | | | | | | |
| Co solid-solubilized in | % by | 1.29 | 1.29 | 1.29 | 1.29 | 1.29 | 1.29 |
| hydroxide particle | mass | | | | | | |
| Co in covering layer | % by | 4.93 | 2.4 | 1.37 | 6.5 | 2.59 | 1.05 |
| | mass | | | | | | |
| Mg | % by | 0.78 | 0.73 | 0.67 | 0.79 | 0.75 | 0.65 |
| | mass | | | | | | |
| Total oxidized cobalt (Co | % by | 5.77 | 3.03 | 1.94 | 7.03 | 3.14 | 1.65 |
| (III)) | mass | | | | | | |
| Total cobalt oxidation rate | % | 92.77 | 82.11 | 72.93 | 90.24 | 80.93 | 70.51 |
| (content by percentage (% | | | | | | | |
| by mass) of oxidized cobalt | | | | | | | |
| (Co (III)) in total Co) | | | | | | | |
| Oxidized cobalt (Co (III)) | % by | 0.84 | 0.63 | 0.57 | 0.53 | 0.55 | 0.60 |
| solid-solubilized in | mass | | | | | | |
| hydroxide particle | | | | | | | |
| Oxidation rate of Co solid- | % | 65.12 | 48.84 | 44.19 | 41.09 | 42.64 | 46.51 |
| solubilized in hydroxide | | | | | | | |
| particle (content by | | | | | | | |
| percentage (% by mass) of | | | | | | | |
| oxidized cobalt (Co (III)) | | | | | | | |
| solid-solubilized in | | | | | | | |
| hydroxide particle to Co | | | | | | | |
| solid-solubilized in | | | | | | | |
| hydroxide particle) | | | | | | | |
| Ratio of content by percentage of | | 1.615 | 1.212 | 1.096 | 0.981 | 1.019 | 1.111 |
| oxidized Co (III) solid-solubilized in | | | | | | | |
| hydroxide particle in classified product | | | | | | | |
| to content by percentage of oxidized | | | | | | | |
| Co solid-solubilized in hydroxide | | | | | | | |
| particle before classification (content | | | | | | | |
| by percentage of solid-solubilized, | | | | | | | |
| oxidized Co (III) in Table 2) | | | | | | | |
| D50 | mm | 5.5 | 10.3 | 18.4 | 3.2 | 5.9 | 12.2 |
| BET | m²/g | 24.8 | 18.4 | 16.4 | 37.1 | 20.1 | 13.9 |

Preparation of Positive Electrode

A composition in the form of slurry was prepared by mixing the positive electrode active material, PTFE, and water in amounts such that the particle of Example or Comparative Example, which is a positive electrode active material:PTFE (polytetrafluoroethylene) as binder:water=80:10:10 in terms of mass ratio of solid contents. Foam nickel (collector) was filled with the composition in the form of slurry, thus prepared, and the composition was dried and then rolled, thereby preparing each positive electrode.

Preparation of Evaluation Cell

A positive electrode to which the sample of each Example or each Comparative Example described above was added was used, a hydrogen storage alloy was used as a negative electrode, and polyolefin nonwoven fabric composed of polyethylene and polypropylene was used as a separator. Further, an electrolytic solution containing 6 mol/L of KOH was used as an electrolytic solution to assemble an evaluation cell, and the items described below were evaluated.

(1) Charge/Discharge Capacity Test at Normal Temperature (25° C.)

After the evaluation cell was stored at 25° C. for 12 hours, the evaluation cell was charged at 0.2 C for 6 hours and then discharged at 0.2 C to 1.0 V. This operation was repeated 10 times to perform activation. The discharge capacity at 10th activation was defined as the charge/discharge capacity at normal temperature.

(2) Charge/Discharge Capacity Test at High Temperature (60° C.)

After the cell after the activation was stored at 60° C. for 4 hours, the discharge capacity was measured when the cell was charged at 0.2 C for 5 hours and discharged at 0.2 C to 1.0V while the temperature was kept at 60° C.

The results of evaluating the alkaline storage batteries using the sample of Example 1 or Comparative Example 1 as a positive electrode are shown in Table 4 described below.

TABLE 4

| | Charge/discharge capacity test at normal temperature | | | | Charge/discharge capacity test at high temperature | | | |
|---|---|---|---|---|---|---|---|---|
| | | | | Relative | | | Relative | Relative |
| | Theoretical | Discharge | Utilization | utilization | Discharge | Utilization | discharge | utilization |
| | capacity | capacity | factor | factor | capacity | factor | capacity | factor |
| | mAh/g | mAh/g | % | Relative % | mAh/g | % | Relative % | Relative % |
| Example 1 | 254.8 | 226.2 | 88.8 | 100.0 | 103.8 | 40.7 | 100.0 | 100.0 |
| Comparative | 258.5 | 227.6 | 88.1 | 99.2 | 97.6 | 37.8 | 94.0 | 92.7 |
| Example 1 | | | | | | | | |

As shown in Table 2 described above, Example 1, where the content by percentage of trivalent cobalt in solid-solubilized cobalt is 30% by mass or more; and as shown in Tables 3 and 4 described above, the ratio of the content by percentage of solid-solubilized trivalent cobalt in the positive electrode active material particles of D10 or less for an alkaline storage battery in the positive electrode active material for an alkaline storage battery to the content by percentage of solid-solubilized trivalent cobalt in the positive electrode active material for an alkaline storage battery is 0.981 (that is, 0.80 or more and 1.20 or less), and the ratio of solid-solubilized trivalent cobalt in the positive electrode active material particles of D90 or more for an alkaline storage battery to the content by percentage of solid-solubilized trivalent cobalt in the positive electrode active material for an alkaline storage battery is 1.111 (that is, 0.80 or more and 1.20 or less), has an excellent utilization factor at normal temperature (25° C.), and an excellent utilization factor can also be obtained at a high temperature (60° C.). Moreover, as shown in Table 2, Example 1 has a value of the particle size distribution width (D90-D10)/D50 of 0.91.

On the other hand, Comparative Example 1, where the ratio of the content by percentage of solid-solubilized trivalent cobalt in the positive electrode active material particles of D10 or less for an alkaline storage battery in the positive electrode active material for an alkaline storage battery to the content by percentage of solid-solubilized trivalent cobalt in the positive electrode active material for an alkaline storage battery is 1.615, has a satisfactory utilization factor at normal temperature (25° C.), but a satisfactory utilization factor cannot be obtained at a high temperature (60° C.).

The positive electrode active material for an alkaline storage battery of the present disclosure exhibits an excellent utilization factor even under a high-temperature condition and therefore has a high utilization value in the field of a positive electrode active material for an alkaline storage battery that can be used in a high temperature environment, for example, in the fields of vehicles and the like.

What is claimed is:

1. A positive electrode active material for an alkaline storage battery, comprising:
a hydroxide particle comprising nickel, the hydroxide particle comprising solid-solubilized cobalt; and
a covering layer comprising cobalt, the covering layer covering the hydroxide particle, wherein
the positive electrode active material has a diffraction peak between diffraction angles of 65° and 66°, the diffraction angles represented by 2θ in a diffraction pattern obtained by X-ray diffraction measurement,
a content by percentage of trivalent cobalt in the solid-solubilized cobalt is 30% by mass or more,
a ratio of a content by percentage of the solid-solubilized trivalent cobalt in positive electrode active material particles for an alkaline storage battery, the particles having a secondary particle diameter (≤D10) where a cumulative volume percentage is 10.0% by volume or less, in the positive electrode active material for an alkaline storage battery to the content by percentage of the solid-solubilized trivalent cobalt in the positive electrode active material for an alkaline storage battery is 0.80 or more and 1.20 or less, and a ratio of a content by percentage of the solid-solubilized trivalent cobalt in positive electrode active material particles for an alkaline storage battery, the particles having a secondary particle diameter (≥D90) where a cumulative volume percentage is 90.0% by volume or more, in the positive electrode active material for an alkaline storage battery to the content by percentage of the solid-solubilized trivalent cobalt in the positive electrode active material for an alkaline storage battery is 0.80 or more and 1.20 or less.

2. The positive electrode active material for an alkaline storage battery according to claim 1, wherein the diffraction peak is derived from a trivalent cobalt compound represented by CoHO₂.

3. The positive electrode active material for an alkaline storage battery according to claim 1, wherein Secondary particle diameter (D90) of the positive electrode active material for an alkaline storage battery, where cumulative volume percentage is 90.0% by volume—Secondary particle diameter (D10) of the positive electrode active material for an alkaline storage battery, where cumulative volume percentage is 10.0% by volume]/Secondary particle diameter (D50) of the positive electrode active material for an alkaline storage battery, where the cumulative volume percentage is 50.0% by volume, is 0.85 or more.

4. A positive electrode comprising the positive electrode active material for an alkaline storage battery according to claim 1.

5. An alkaline storage battery comprising the positive electrode according to claim 4.
